(19) United States
(12) Patent Application Publication
(10) Pub. No.: US 2026/0148272 A1
(43) Pub. Date: May 28, 2026

(54) SHOPPING AND LIFE COMPANION WITH ARTIFICIAL INTELLIGENCE

(71) Applicant: iFashions Inc, Lafayette, CA (US)

(72) Inventor: Ying Zheng, Lafayette, CA (US)

(73) Assignee: iFashions Inc, Lafayette, CA (US)

(21) Appl. No.: 18/959,483

(22) Filed: Nov. 25, 2024

(51) Int. Cl. G06Q 30/0601

(52) U.S. Cl. CPC G06Q 30/0617; G06Q 30/0629; G06Q 30/0631; G06Q 30/0643

(57) ABSTRACT

Embodiments of the present disclosure may include a method for personalizing a shopping experience using an artificial intelligence (AI) companion agent

### BACKGROUND OF THE INVENTION

Embodiments of the present disclosure include a method for personalizing a shopping experience and a life experience using an artificial intelligence companion agent.

### BRIEF SUMMARY

Embodiments of the present disclosure may include a method for personalizing a shopping and life experience using an artificial intelligence (AI) companion agent, including detecting, by one or more processors, an encounter request from a user. In some embodiments, an artificial intelligence engine may be coupled to the one or more processors. In some embodiments, the artificial intelligence engine may be trained by human experts in the field.

In some embodiments, the AI companion agent may be configured to be displayed in LED/OLED displays, Android/iOS tablets, Laptops/PCs, or VR/AR goggles. In some embodiments, a set of multi-layer info panels coupled to the one or more processors may be configured to overlay graphics on top of the AI companion agent. In some embodiments, the AI companion agent may be configured to be displayed with an appearance of a real human or a humanoid or a cartoon character or an animal character based on the user's choice.

In some embodiments, the real human can be a movie star. In some embodiments, a set of pictures depicting the user's choice can be uploaded to the artificial intelligence engine. In some embodiments, the appearance of the AI companion agent could be determined by analysis of the set of pictures by the artificial intelligence engine.

In some embodiments, the AI companion agent may be configured to mimic different personalities. In some embodiments, the AI companion agent's gender, age and ethnicity may be determined by the artificial Intelligence's analysis on input from the user. In some embodiments, the AI companion agent may be configured to be displayed in full body or half body portrait mode or a face on top of a moving robot.

In some embodiments, the artificial intelligence engine may be configured for real-time speech recognition, speech to text generation, real-time dialog generation, text to speech generation, voice-driven animation, and human avatar generation. In some embodiments, the AI companion agent may be figured to share personalized promotions based on the user's shopping history.

In some embodiments, the AI companion can be run both online with internet and offline without internet. Embodiments may also include accessing the user's taste history on clothing. In some embodiments, the AI companion agent searches and retrieves the user's past preferences and purchase history related to clothing items.

Embodiments may also include familiarizing with the user's clothing preferences. In some embodiments, the AI companion agent analyzes and understands the user's preferred types of clothing, such as dresses, shirts, and preferred colors. Embodiments may also include engaging in a dialog with the user. In some embodiments, the AI companion agent inquiries about the specific clothing item the user desires, including type and color.

Embodiments may also include allowing detailed user inputs. In some embodiments, the user describes the desired clothing item in detail, specifying style, color, and other characteristics. Embodiments may also include recommending clothing based on user preferences. In some embodiments, the AI companion agent suggests suitable clothing items based on the user's taste history, occasion, and personal style.

Embodiments may also include extending recommendations to family and friends. In some embodiments, the AI companion agent provides clothing suggestions for the user's family members and friends by remembering their names and preferences. Embodiments may also include differentiating between similar items. In some embodiments, the AI companion agent informs the user about the differences between the similar items.

Embodiments may also include prompting related purchases. In some embodiments, the AI companion agent reminds the user to buy related items when a particular item may be selected. Embodiments may also include training on various fields of knowledge. In some embodiments, the AI companion agent may be equipped with knowledge from different domains to assist the user comprehensively.

Embodiments of the present disclosure may also include, the method for personalizing a shopping experience using an artificial intelligence (AI) companion agent of Claim 1. In some embodiments, the AI companion agent may be configured to provide multi-platform accessibility. In some embodiments, the AI companion agent can operate on a TV screen or as an app on a smartphone.

Embodiments of the present disclosure may also include, the method for personalizing a shopping experience using an artificial intelligence (AI) companion agent of Claim 1. In some embodiments, the artificial intelligence engine may be configured to emulate different voices and use different languages.

Embodiments of the present disclosure may also include a method for using an artificial intelligence (AI) companion agent as a life companion, including Detecting, by one or more processors, an encounter request from a user. In some embodiments, an artificial intelligence engine may be coupled to the one or more processors. In some embodiments, the artificial intelligence engine may be trained by human experts in the field.

In some embodiments, the AI companion agent may be configured to be displayed in LED/OLED displays, Android/iOS tablets, Laptops/PCs, or VR/AR goggles. In some embodiments, a set of multi-layer info panels coupled to the one or more processors may be configured to overlay graphics on top of the AI companion agent. In some embodiments, the AI companion agent may be configured to be displayed with an appearance of a real human or a humanoid or a cartoon character or an animal character based on the user's choice.

In some embodiments, the real human can be a movie star. In some embodiments, a set of pictures depicting the user's choice can be uploaded to the artificial intelligence engine. In some embodiments, the appearance of the AI companion agent could be determined by analysis of the set of pictures by the artificial intelligence engine.

In some embodiments, the AI companion agent may be configured to mimic different personalities. In some embodiments, the AI companion agent's gender, age and ethnicity may be determined by the artificial Intelligence's analysis on input from the user. In some embodiments, the AI companion agent may be configured to be displayed in full body or half body portrait mode or a face on top of a moving robot.

In some embodiments, the artificial intelligence engine may be configured for real-time speech recognition, speech to text generation, real-time dialog generation, text to speech generation, voice-driven animation, and human avatar generation. In some embodiments, the AI companion agent may be figured to share personalized promotions based on the user's shopping history.

In some embodiments, the AI companion can be run both online with internet and offline without internet. Embodiments may also include customizing the AI agent's appearance. In some embodiments, the user can design and change the AI agent's visual representation to resemble a movie star, animal, or cartoon character. Embodiments may also include retrieving user's life history.

In some embodiments, the AI agent searches and retrieves the user's past preferences and history on life, view, news, and food preferences. Embodiments may also include engaging in topical conversations. In some embodiments, the AI agent chats with the user on topics of interest to the user, including current news, and selects news articles based on the user's preferences and interests.

Embodiments may also include conversing about selected topics. In some embodiments, the AI agent engages in conversations about topics the user selects for any day. Embodiments may also include discussing shopping experiences. In some embodiments, the AI agent engages in conversations with the user about their shopping experiences and may give suggestions.

Embodiments may also include recommending relevant products. Embodiments may also include providing knowledges in different domains. In some embodiments, the different domains may include domains of beauty evaluation, nutrients, important features and trends of a specific product and other fields. Embodiments may also include helping users compare different products. Embodiments may also include sending reminders for relevant activities and products.

In some embodiments, the AI companion agent may be configured to provide multi-platform accessibility. In some embodiments, the AI companion agent can operate on a TV screen or as an app on a smartphone. In some embodiments, the artificial intelligence engine may be configured to emulate different voices and use different languages.

Embodiments of the present disclosure may also include a method for using an artificial intelligence (AI) companion agent as a life and shopping companion, including Detecting, by one or more processors, an encounter request from a user. In some embodiments, an artificial intelligence engine may be coupled to the one or more processors. In some embodiments, the artificial intelligence engine may be trained by human experts in the field.

In some embodiments, the AI companion agent may be configured to be displayed in LED/OLED displays, Android/iOS tablets, Laptops/PCs, or VR/AR goggles. In some embodiments, a set of multi-layer info panels coupled to the one or more processors may be configured to overlay graphics on top of the AI companion agent. In some embodiments, the AI companion agent may be configured to be displayed with an appearance of a real human or a humanoid or a cartoon character or an animal character based on the user's choice.

In some embodiments, the real human can be a movie star. In some embodiments, a set of pictures depicting the user's choice can be uploaded to the artificial intelligence engine. In some embodiments, the appearance of the AI companion agent could be determined by analysis of the set of pictures by the artificial intelligence engine.

In some embodiments, the AI companion agent may be configured to mimic different personalities. In some embodiments, the AI companion agent's gender, age and ethnicity may be determined by the artificial Intelligence's analysis on input from the user. In some embodiments, the AI companion agent may be configured to be displayed in full body or half body portrait mode or a face on top of a moving robot.

In some embodiments, the artificial intelligence engine may be configured for real-time speech recognition, speech to text generation, real-time dialog generation, text to speech generation, voice-driven animation, and human avatar generation. In some embodiments, the AI companion agent may be figured to share personalized promotions based on the user's shopping history.

In some embodiments, the AI companion can be run both online with internet and offline without internet. Embodiments may also include accessing the user's taste history on clothing. In some embodiments, the AI companion agent searches and retrieves the user's past preferences and purchase history related to clothing items.

Embodiments may also include familiarizing with the user's clothing preferences. In some embodiments, the AI companion agent analyzes and understands the user's preferred types of clothing, such as dresses, shirts, and preferred colors. Embodiments may also include engaging in a dialog with the user. In some embodiments, the AI companion agent inquiries about the specific clothing item the user desires, including type and color.

Embodiments may also include allowing detailed user inputs. In some embodiments, the user describes the desired clothing item in detail, specifying style, color, and other characteristics. Embodiments may also include recommending clothing based on user preferences. In some embodiments, the AI companion agent suggests suitable clothing items based on the user's taste history, occasion, and personal style.

Embodiments may also include extending recommendations to family and friends. In some embodiments, the AI companion agent provides clothing suggestions for the user's family members and friends by remembering their names and preferences. Embodiments may also include differentiating between similar items. In some embodiments, the AI companion agent informs the user about the differences between the similar items.

Embodiments may also include prompting related purchases. In some embodiments, the AI companion agent reminds the user to buy related items when a particular item may be selected. Embodiments may also include training on various fields of knowledge. In some embodiments, the AI companion agent may be equipped with knowledge from different domains to assist the user comprehensively.

Embodiments may also include retrieving user's life history. In some embodiments, the AI agent searches and retrieves the user's past preferences and history on life, view, news, and food preferences. Embodiments may also include engaging in topical conversations. In some embodiments, the AI agent chats with the user on topics of interest to the user, including current news, and selects news articles based on the user's preferences and interests.

Embodiments may also include conversing about selected topics. In some embodiments, the AI agent engages in conversations about topics the user selects for any day. Embodiments may also include discussing shopping experiences. In some embodiments, the AI agent engages in conversations with the user about their shopping experiences and may give suggestions.

Embodiments may also include recommending relevant products. Embodiments may also include providing knowledges in different domains. In some embodiments, the different domains may include domains of beauty evaluation, nutrients, important features and trends of a specific product and other fields. Embodiments may also include helping users compare different products. Embodiments may also include sending reminders for relevant activities and products.

In some embodiments, the AI companion agent may be configured to provide multi-platform accessibility. In some embodiments, the AI companion agent can operate on a TV screen or as an app on a smartphone. In some embodiments, the artificial intelligence engine may be configured to emulate different voices and use different languages.

### BRIEF DESCRIPTION OF THE FIGURES

FIG. 1A is a flowchart illustrating A method for personalizing a shopping experience, according to some embodiments of the present disclosure.

FIG. 1B is a flowchart extending from FIG. 1A and further illustrating the method for personalizing a shopping experience, according to some embodiments of the present disclosure.

FIG. 2A is a flowchart illustrating a method for using an artificial intelligence (AI) companion agent, according to some embodiments of the present disclosure.

FIG. 2B is a flowchart extending from FIG. 2A and further illustrating the method for using an artificial intelligence (AI) companion agent, according to some embodiments of the present disclosure.

FIG. 3A is a flowchart illustrating a method for using an artificial intelligence (AI) companion agent, according to some embodiments of the present disclosure.

FIG. 3B is a flowchart extending from FIG. 3A and further illustrating the method for using an artificial intelligence (AI) companion agent, according to some embodiments of the present disclosure.

FIG. 3C is a flowchart extending from FIG. 3B and further illustrating the method for using an artificial intelligence (AI) companion agent from FIG. 3A, according to some embodiments of the present disclosure.

FIG. 4 is a diagram showing an example of a method for personalizing a shopping experience and a life experience using an artificial intelligence companion agent, according to some embodiments of the present disclosure.

FIG. 5 is a diagram showing a second example of a method for personalizing a shopping experience and a life experience using an artificial intelligence companion agent, according to some embodiments of the present disclosure.

FIG. 6 is a diagram showing a third example of a method for personalizing a shopping experience and a life experience using an artificial intelligence companion agent, according to some embodiments of the present disclosure.

FIG. 7 is a diagram showing a fourth example of a method for personalizing a shopping experience and a life experience using an artificial intelligence companion agent, according to some embodiments of the present disclosure.

FIG. 8 is a diagram showing a fifth example of a method for personalizing a shopping experience and a life experience using an artificial intelligence companion agent, according to some embodiments of the present disclosure.

FIG. 9 is a diagram showing a sixth example of a method for personalizing a shopping experience and a life experience using an artificial intelligence companion agent, according to some embodiments of the present disclosure.

FIG. 10 is a diagram showing a seventh example of a method for personalizing a shopping experience and a life experience using an artificial intelligence companion agent, according to some embodiments of the present disclosure.

### DETAILED DESCRIPTION

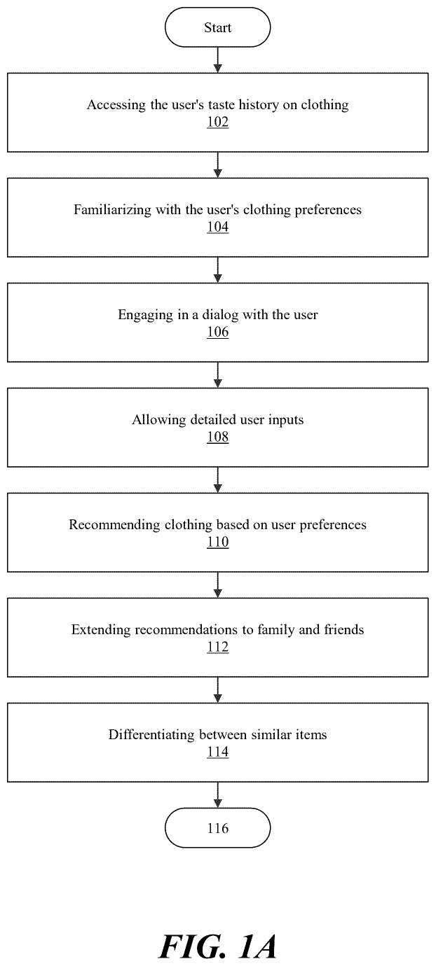

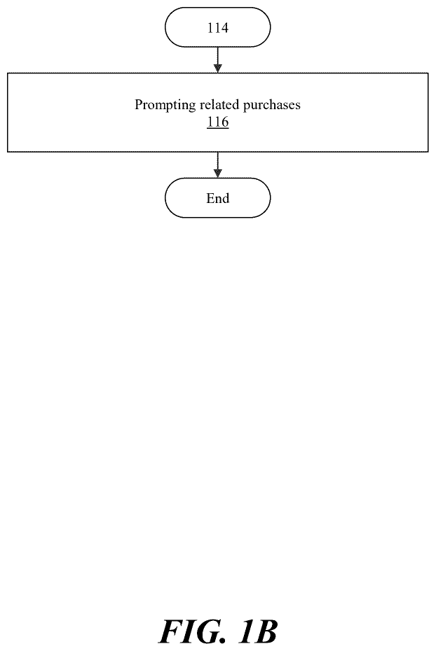

FIGS. 1A to 1B are flowcharts that describe a method for personalizing a shopping experience, according to some embodiments of the present disclosure. In some embodiments, at 102, the method may include accessing the user's taste history on clothing. At 104, the method may include familiarizing with the user's clothing preferences. At 110, the method may include recommending clothing based on user preferences. At 112, the method may include extending recommendations to family and friends. At 114, the method may include differentiating between similar items. At 116, the method may include prompting related purchases.

In some embodiments, Detecting, by one or more processors, an encounter request from a user. An artificial intelligence engine may be coupled to the one or more processors. The artificial intelligence engine may be trained by human experts in the field. The AI companion agent may be configured to be displayed in LED/OLED displays, Android/iOS tablets, Laptops/PCs, or VR/AR goggles. A set of multi-layer info panels coupled to the one or more processors may be configured to overlay graphics on top of the AI companion agent.

In some embodiments, the AI companion agent may be configured to be displayed with an appearance of a real human or a humanoid or a cartoon character or an animal character based on the user's choice. The real human can be a movie star. A set of pictures depicting the user's choice can be uploaded to the artificial intelligence engine. The appearance of the AI companion agent could be determined by analysis of the set of pictures by the artificial intelligence engine.

In some embodiments, the AI companion agent may be configured to mimic different personalities. The AI companion agent's gender, age and ethnicity may be determined by the artificial Intelligence's analysis on input from the user. The AI companion agent may be configured to be displayed in full body or half body portrait mode or a face on top of a moving robot. The artificial intelligence engine may be configured for real-time speech recognition, speech to text generation, real-time dialog generation, text to speech generation, voice-driven animation, and human avatar generation.

In some embodiments, the AI companion agent may be figured to share personalized promotions based on the user's shopping history. The AI companion can be run both online with internet and offline without internet. The AI companion agent searches and retrieves the user's past preferences and purchase history related to clothing items. At 106, the familiarizing may include engaging in a dialog with the user. At 108, the familiarizing may include allowing detailed user inputs.

In some embodiments, the AI companion agent may analyze and understands the user's preferred types of clothing, such as dresses, shirts, and preferred colors. The AI companion agent inquiries about the specific clothing item the user desires, including type and color. The user may describe the desired clothing item in detail, specifying style, color, and other characteristics. The AI companion agent may suggest suitable clothing items based on the user's taste history, occasion, and personal style.

In some embodiments, the AI companion agent may provide clothing suggestions for the user's family members and friends by remembering their names and preferences. The AI companion agent may inform the user about the differences between the similar items. The AI companion agent may remind the user to buy related items when a particular item may be selected. Training on various fields of knowledge. The AI companion agent may be equipped with knowledge from different domains to assist the user comprehensively.

In some embodiments, the AI companion agent may be configured to provide multi-platform accessibility. The AI companion agent can operate on a TV screen or as an app on a smartphone.

In some embodiments, the artificial intelligence engine may be configured to emulate different voices and use different languages.

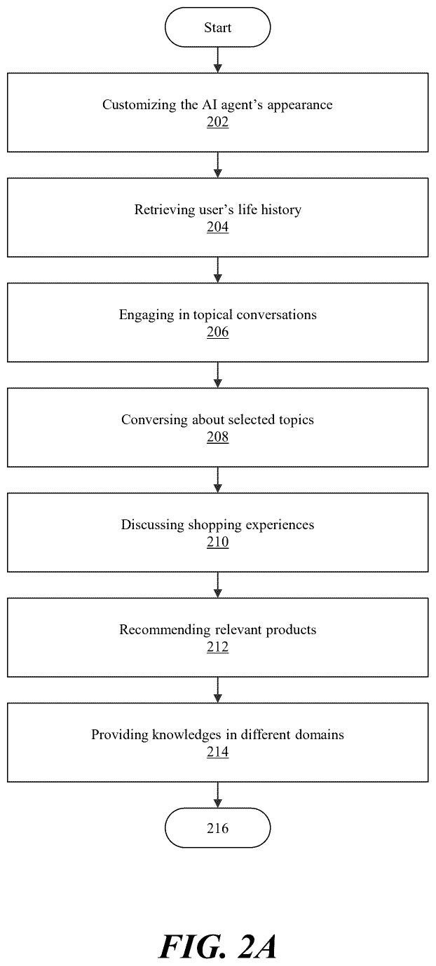

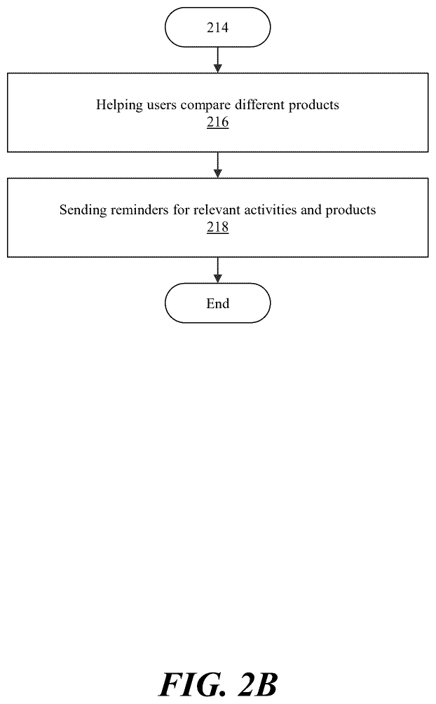

FIGS. 2A to 2B are flowcharts that describe a method for using an artificial intelligence (AI) companion agent, according to some embodiments of the present disclosure. In some embodiments, at 202, the method may include customizing the AI agent's appearance. At 204, the method may include retrieving user's life history. At 206, the method may include engaging in topical conversations. At 208, the method may include conversing about selected topics. At 210, the method may include discussing shopping experiences. At 212, the method may include recommending relevant products. At 214, the method may include providing knowledges in different domains. At 216, the method may include helping users compare different products. At 218, the method may include sending reminders for relevant activities and products.

In some embodiments, Detecting, by one or more processors, an encounter request from a user. An artificial intelligence engine may be coupled to the one or more processors. The artificial intelligence engine may be trained by human experts in the field. The AI companion agent may be configured to be displayed in LED/OLED displays, Android/iOS tablets, Laptops/PCs, or VR/AR goggles. A set of multi-layer info panels coupled to the one or more processors may be configured to overlay graphics on top of the AI companion agent.

In some embodiments, the AI companion agent may be configured to be displayed with an appearance of a real human or a humanoid or a cartoon character or an animal character based on the user's choice. The real human can be a movie star. A set of pictures depicting the user's choice can be uploaded to the artificial intelligence engine. The appearance of the AI companion agent could be determined by analysis of the set of pictures by the artificial intelligence engine.

In some embodiments, the AI companion agent may be configured to mimic different personalities. The AI companion agent's gender, age and ethnicity may be determined by the artificial Intelligence's analysis on input from the user. The AI companion agent may be configured to be displayed in full body or half body portrait mode or a face on top of a moving robot. The artificial intelligence engine may be configured for real-time speech recognition, speech to text generation, real-time dialog generation, text to speech generation, voice-driven animation, and human avatar generation.

In some embodiments, the AI companion agent may be figured to share personalized promotions based on the user's shopping history. The AI companion can be run both online with internet and offline without internet. The user can design and change the AI agent's visual representation to resemble a movie star, animal, or cartoon character. The AI agent searches and retrieves the user's past preferences and history on life, view, news, and food preferences.

In some embodiments, the AI agent chats with the user on topics of interest to the user, including current news, and selects news articles based on the user's preferences and interests. The AI agent may engage in conversations about topics the user may select for any day. The AI agent may engage in conversations with the user about their shopping experiences and may give suggestions. The different domains may comprise domains of beauty evaluation, nutrients, important features and trends of a specific product and other fields. In some embodiments, the AI companion agent may be configured to provide multi-platform accessibility. The AI companion agent can operate on a TV screen or as an app on a smartphone. In some embodiments, the artificial intelligence engine may be configured to emulate different voices and use different languages.

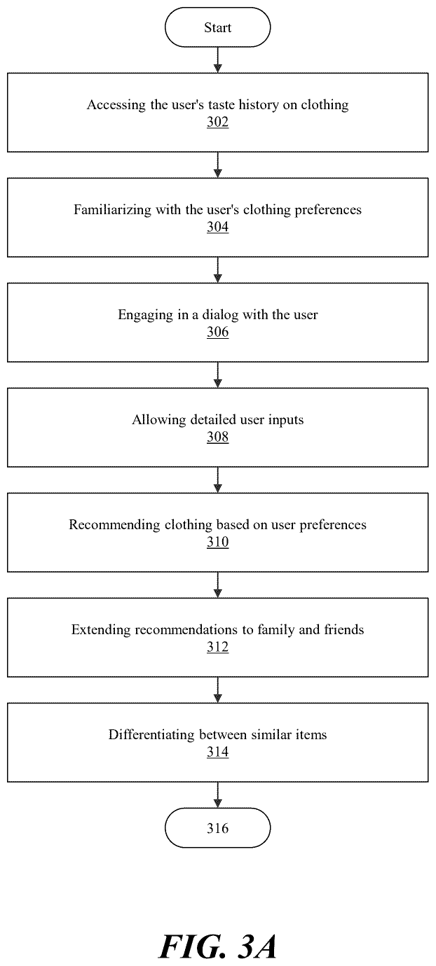

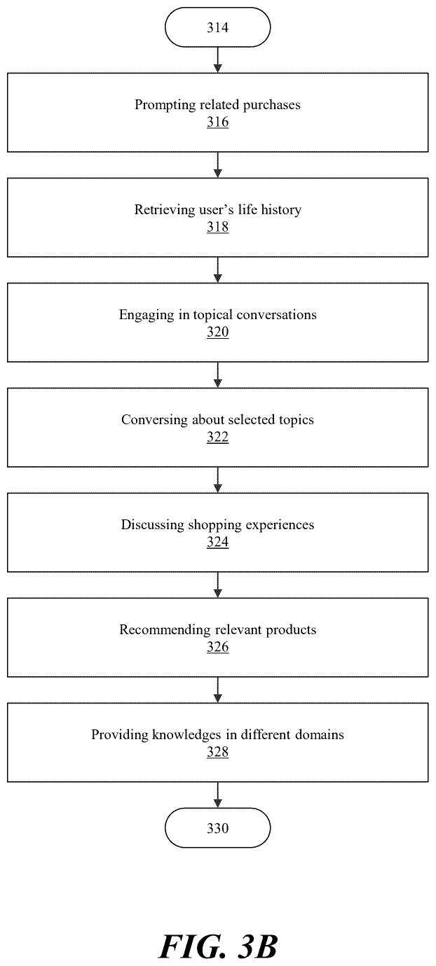

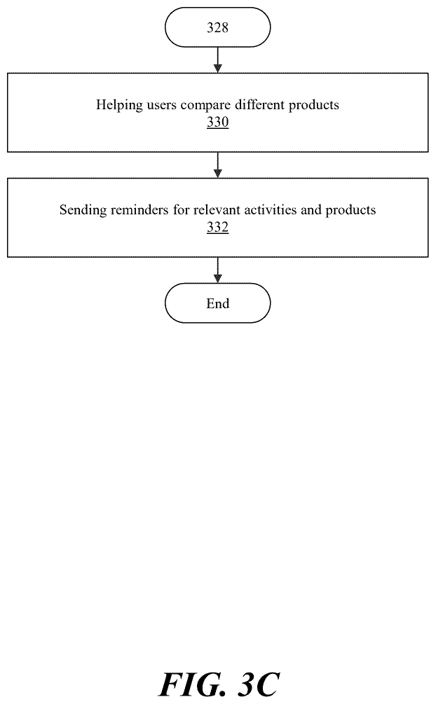

FIGS. 3A to 3C are flowcharts that describe a method for using an artificial intelligence (AI) companion agent, according to some embodiments of the present disclosure. In some embodiments, at 302, the method may include accessing the user's taste history on clothing. At 304, the method may include familiarizing with the user's clothing preferences. At 310, the method may include recommending clothing based on user preferences. At 312, the method may include extending recommendations to family and friends. At 314, the method may include differentiating between similar items.

In some embodiments, at 316, the method may include prompting related purchases. At 318, the method may include retrieving user's life history. At 320, the method may include engaging in topical conversations. At 322, the method may include conversing about selected topics. At 324, the method may include discussing shopping experiences. At 326, the method may include recommending relevant products. At 328, the method may include providing knowledges in different domains. At 330, the method may include helping users compare different products. At 332, the method may include sending reminders for relevant activities and products.

In some embodiments, Detecting, by one or more processors, an encounter request from a user. An artificial intelligence engine may be coupled to the one or more processors. The artificial intelligence engine may be trained by human experts in the field. The AI companion agent may be configured to be displayed in LED/OLED displays, Android/iOS tablets, Laptops/PCs, or VR/AR goggles. A set of multi-layer info panels coupled to the one or more processors may be configured to overlay graphics on top of the AI companion agent.

In some embodiments, the AI companion agent may be configured to be displayed with an appearance of a real human or a humanoid or a cartoon character or an animal character based on the user's choice. The real human can be a movie star. A set of pictures depicting the user's choice can be uploaded to the artificial intelligence engine. The appearance of the AI companion agent could be determined by analysis of the set of pictures by the artificial intelligence engine.

In some embodiments, the AI companion agent may be configured to mimic different personalities. The AI companion agent's gender, age and ethnicity may be determined by the artificial Intelligence's analysis on input from the user. The AI companion agent may be configured to be displayed in full body or half body portrait mode or a face on top of a moving robot. The artificial intelligence engine may be configured for real-time speech recognition, speech to text generation, real-time dialog generation, text to speech generation, voice-driven animation, and human avatar generation.

In some embodiments, the AI companion agent may be figured to share personalized promotions based on the user's shopping history. The AI companion can be run both online with internet and offline without internet. The AI companion agent searches and retrieves the user's past preferences and purchase history related to clothing items. At 306, the familiarizing may include engaging in a dialog with the user. At 308, the familiarizing may include allowing detailed user inputs.

In some embodiments, the AI companion agent may analyze and understands the user's preferred types of clothing, such as dresses, shirts, and preferred colors. The AI companion agent inquiries about the specific clothing item the user desires, including type and color. The user may describe the desired clothing item in detail, specifying style, color, and other characteristics. The AI companion agent may suggest suitable clothing items based on the user's taste history, occasion, and personal style.

In some embodiments, the AI companion agent may provide clothing suggestions for the user's family members and friends by remembering their names and preferences. The AI companion agent may inform the user about the differences between the similar items. The AI companion agent may remind the user to buy related items when a particular item may be selected. Training on various fields of knowledge. The AI companion agent may be equipped with knowledge from different domains to assist the user comprehensively.

In some embodiments, the AI agent searches and retrieves the user's past preferences and history on life, view, news, and food preferences. The AI agent chats with the user on topics of interest to the user, including current news, and selects news articles based on the user's preferences and interests. The AI agent may engage in conversations about topics the user may select for any day. The AI agent may engage in conversations with the user about their shopping experiences and may give suggestions. The different domains may comprise domains of beauty evaluation, nutrients, important features and trends of a specific product and other fields. In some embodiments, the AI companion agent may be configured to provide multi-platform accessibility. The AI companion agent can operate on a TV screen or as an app on a smartphone. In some embodiments, the artificial intelligence engine may be configured to emulate different voices and use different languages.

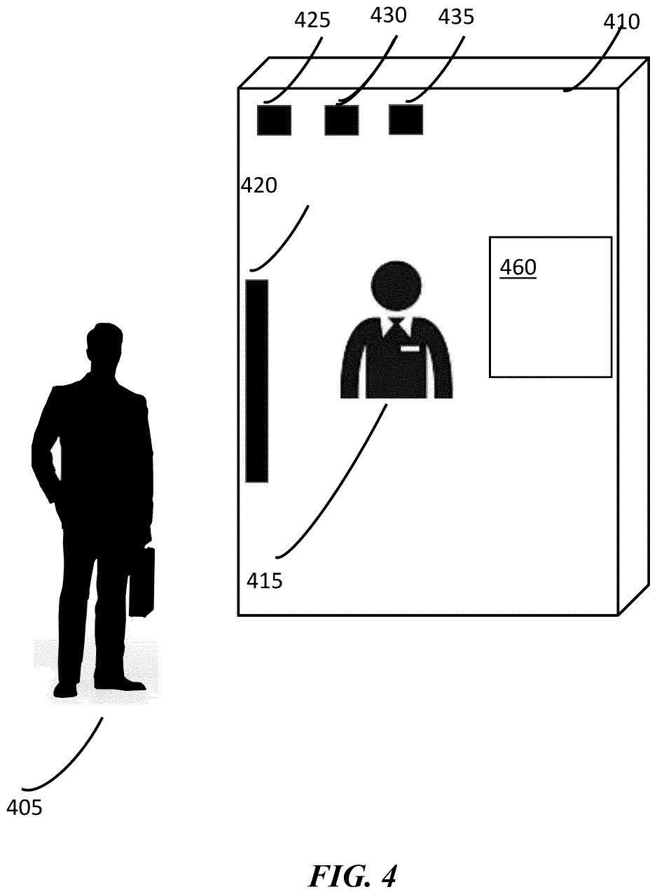

FIG. 4 is a diagram showing an example that describes a first example of a method for personalizing a shopping experience and a life experience using an artificial intelligence companion agent, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to be used. In some embodiments, other users can use this service descripted in this paragraph.

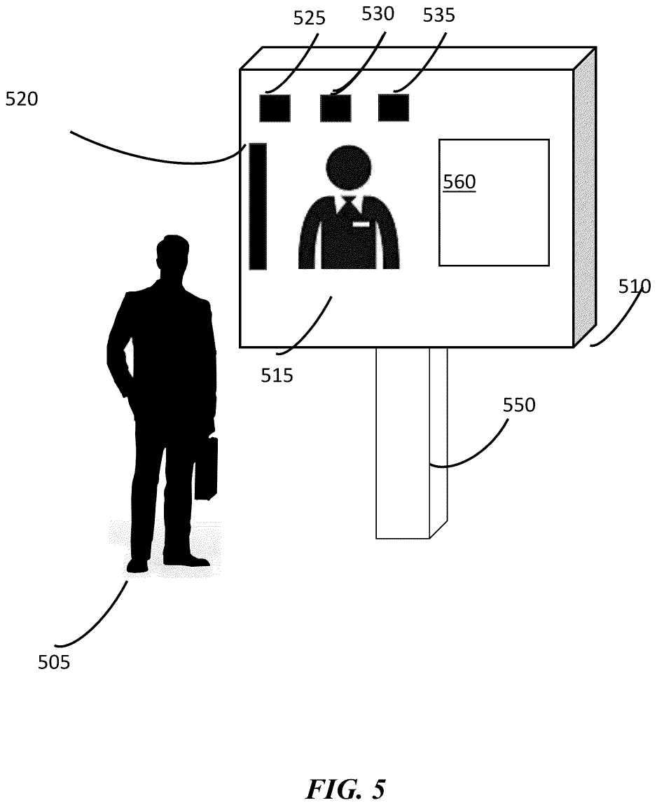

FIG. 5 is a diagram showing a second example of a method for personalizing a shopping experience and a life experience using an artificial intelligence companion agent, according to some embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used. In some embodiments, other users can use this service descripted in this paragraph.

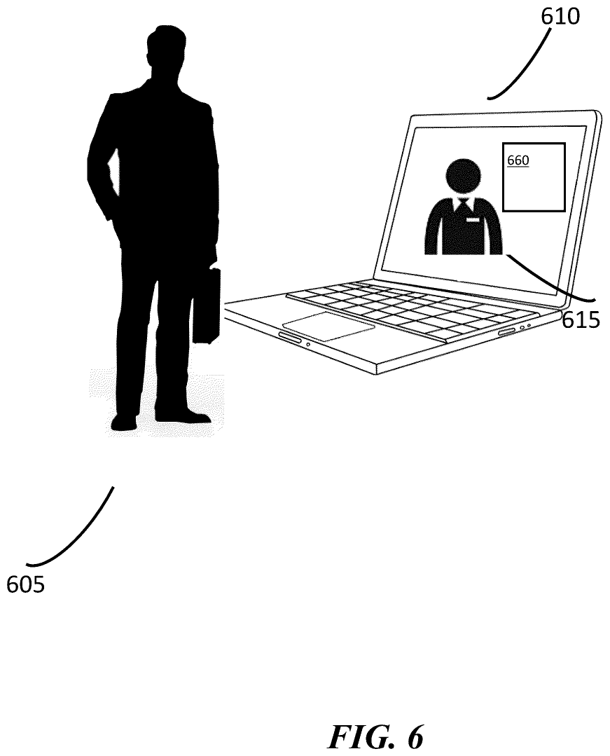

FIG. 6 is a diagram showing a third example of a method for personalizing a shopping experience and a life experience using an artificial intelligence companion agent, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer, or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph.

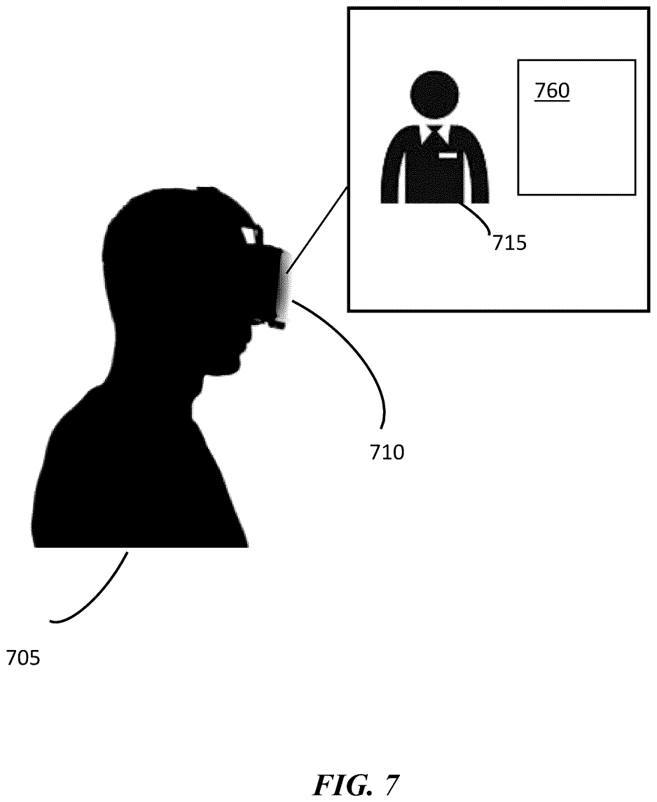

FIG. 7 is a diagram showing a fourth example of a method for personalizing a shopping experience and a life experience using an artificial intelligence companion agent, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service descripted in this paragraph.

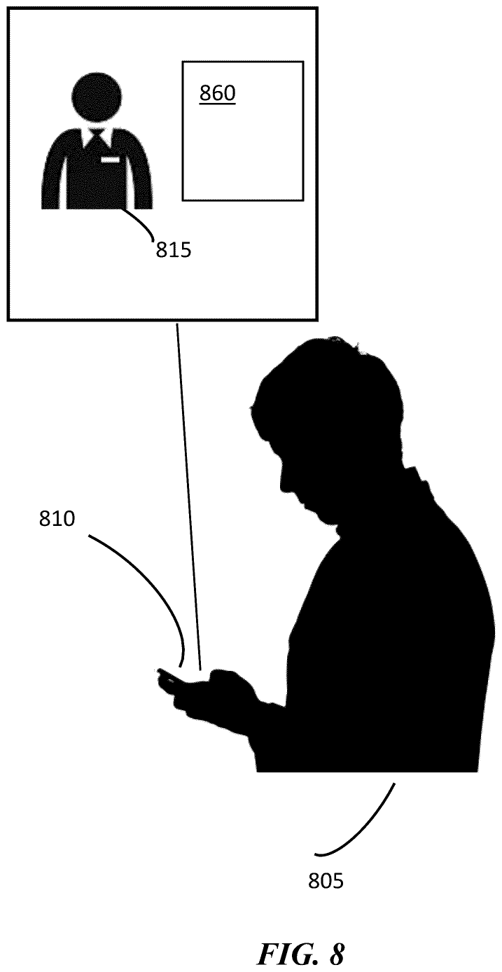

FIG. 8 is a diagram showing a fifth example of a method for personalizing a shopping experience and a life experience using an artificial intelligence companion agent, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph.

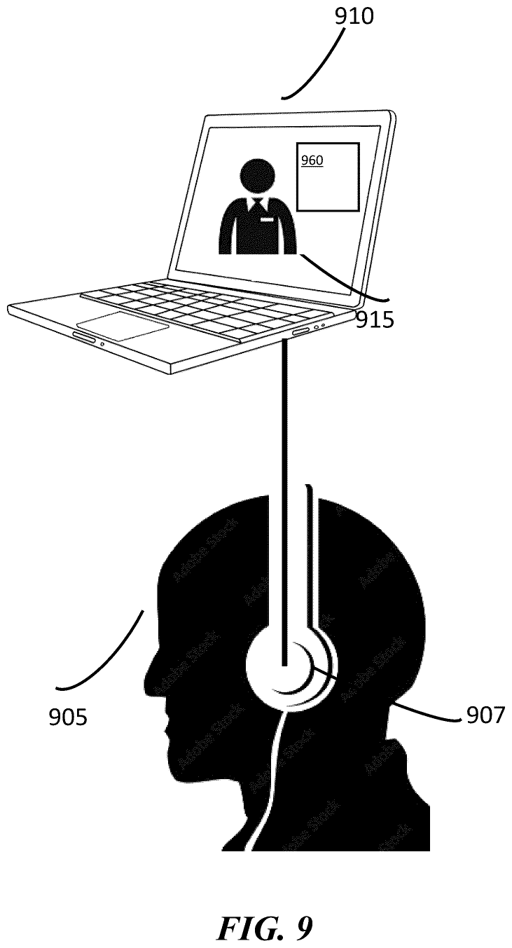

FIG. 9 is a diagram showing a sixth example of a method for personalizing a shopping experience and a life experience using an artificial intelligence companion agent, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 is active on the computer 910. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph.

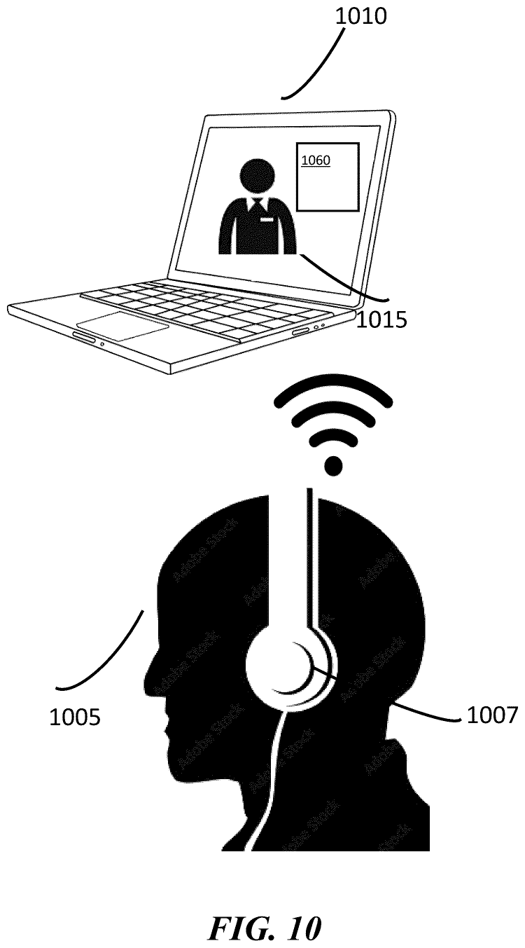

FIG. 10 is a diagram showing a seventh example of a method for personalizing a shopping experience and a life experience using an artificial intelligence companion agent, according to some embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices relate to wireless means to the headset. In some embodiments, a processor and a server are connected to the computer 1010. In some embodiments, an interactive keyboard is connected to the computer 1010. In some embodiments, an AI visual assistant 1015 is active on the computer 1010. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph.

1. A method for personalizing a shopping experience using an artificial intelligence (AI ) companion agent, comprising:
Detecting, by one or more processors, an encounter request from a user, wherein an artificial intelligence engine is coupled to the one or more processors, wherein the artificial intelligence engine is trained by human experts in the field, wherein the AI companion agent is configured to be displayed in LED/OLED displays, Android/iOS tablets, Laptops/PCs, or VR/AR goggles, wherein a set of multi-layer info panels coupled to the one or more processors are configured to overlay graphics on top of the AI companion agent, wherein the AI companion agent is configured to be displayed with an appearance of a real human or a humanoid or a cartoon character or an animal character based on the user's choice, wherein the real human can be a movie star, wherein a set of pictures depicting the user's choice can be uploaded to the artificial intelligence engine, wherein the appearance of the AI companion agent could be determined by analysis of the set of pictures by the artificial intelligence engine, wherein the AI companion agent is configured to mimic different personalities, wherein the AI companion agent's gender, age and ethnicity is determined by the artificial Intelligence's analysis on input from the user; wherein the AI companion agent is configured to be displayed in full body or half body portrait mode or a face on top of a moving robot, wherein the artificial intelligence engine is configured for real-time speech recognition, speech to text generation, real-time dialog generation, text to speech generation, voice-driven animation, and human avatar generation, wherein the AI companion agent is figured to share personalized promotions based on the user's shopping history, wherein the AI companion can be run both online with internet and offline without internet;
Accessing the user's taste history on clothing, wherein the AI companion agent searches and retrieves the user's past preferences and purchase history related to clothing items;
Familiarizing with the user's clothing preferences, wherein the AI companion agent analyzes and understands the user's preferred types of clothing, such as dresses, shirts, and preferred colors;
Engaging in a dialog with the user, wherein the AI companion agent inquiries about the specific clothing item the user desires, including type and color;
Allowing detailed user inputs, wherein the user describes the desired clothing item in detail, specifying style, color, and other characteristics;
Recommending clothing based on user preferences, wherein the AI companion agent suggests suitable clothing items based on the user's taste history, occasion, and personal style;
Extending recommendations to family and friends, wherein the AI companion agent provides clothing suggestions for the user's family members and friends by remembering their names and preferences;
Differentiating between similar items, wherein the AI companion agent informs the user about the differences between the similar items;
Prompting related purchases, wherein the AI companion agent reminds the user to buy related items when a particular item is selected;
Training on various fields of knowledge, wherein the AI companion agent is equipped with knowledge from different domains to assist the user comprehensively.

2. The method for personalizing a shopping experience using an artificial intelligence (AI ) companion agent of claim 1, wherein the AI companion agent is configured to provide multi-platform accessibility, wherein the AI companion agent can operate on a TV screen or as an app on a smartphone.

3. The method for personalizing a shopping experience using an artificial intelligence (AI ) companion agent of claim 1, wherein the artificial intelligence engine is configured to emulate different voices and use different languages.

4. A method for using an artificial intelligence (AI ) companion agent as a life companion, comprising:
Detecting, by one or more processors, an encounter request from a user, wherein an artificial intelligence engine is coupled to the one or more processors, wherein the artificial intelligence engine is trained by human experts in the field, wherein the AI companion agent is configured to be displayed in LED/OLED displays, Android/iOS tablets, Laptops/PCs, or VR/AR goggles, wherein a set of multi-layer info panels coupled to the one or more processors are configured to overlay graphics on top of the AI companion agent, wherein the AI companion agent is configured to be displayed with an appearance of a real human or a humanoid or a cartoon character or an animal character based on the user's choice, wherein the real human can be a movie star, wherein a set of pictures depicting the user's choice can be uploaded to the artificial intelligence engine, wherein the appearance of the AI companion agent could be determined by analysis of the set of pictures by the artificial intelligence engine, wherein the AI companion agent is configured to mimic different personalities, wherein the AI companion agent's gender, age and ethnicity is determined by the artificial Intelligence's analysis on input from the user; wherein the AI companion agent is configured to be displayed in full body or half body portrait mode or a face on top of a moving robot, wherein the artificial intelligence engine is configured for real-time speech recognition, speech to text generation, real-time dialog generation, text to speech generation, voice-driven animation, and human avatar generation, wherein the AI companion agent is figured to share personalized promotions based on the user's shopping history, wherein the AI companion can be run both online with internet and offline without internet;
Customizing the AI agent's appearance, wherein the user can design and change the AI agent's visual representation to resemble a movie star, animal, or cartoon character;
Retrieving user's life history, wherein the AI agent searches and retrieves the user's past preferences and history on life, view, news, and food preferences;
Engaging in topical conversations, wherein the AI agent chats with the user on topics of interest to the user, including current news, and selects news articles based on the user's preferences and interests;
Conversing about selected topics, wherein the AI agent engages in conversations about topics the user selects for any day;
Discussing shopping experiences, wherein the AI agent engages in conversations with the user about their shopping experiences and may give suggestions;
Recommending relevant products;
Providing knowledges in different domains, wherein the different domains comprise domains of beauty evaluation, nutrients, important features and trends of a specific product and other fields;
Helping users compare different products;
Sending reminders for relevant activities and products.

5. The method for personalizing a shopping experience using an artificial intelligence (AI ) companion agent of claim 4, wherein the AI companion agent is configured to provide multi-platform accessibility, wherein the AI companion agent can operate on a TV screen or as an app on a smartphone.

6. The method for personalizing a shopping experience using an artificial intelligence (AI ) companion agent of claim 4, wherein the artificial intelligence engine is configured to emulate different voices and use different languages.

7. A method for using an artificial intelligence (AI ) companion agent as a life and shopping companion, comprising:
Detecting, by one or more processors, an encounter request from a user, wherein an artificial intelligence engine is coupled to the one or more processors, wherein the artificial intelligence engine is trained by human experts in the field, wherein the AI companion agent is configured to be displayed in LED/OLED displays, Android/iOS tablets, Laptops/PCs, or VR/AR goggles, wherein a set of multi-layer info panels coupled to the one or more processors are configured to overlay graphics on top of the AI companion agent, wherein the AI companion agent is configured to be displayed with an appearance of a real human or a humanoid or a cartoon character or an animal character based on the user's choice, wherein the real human can be a movie star, wherein a set of pictures depicting the user's choice can be uploaded to the artificial intelligence engine, wherein the appearance of the AI companion agent could be determined by analysis of the set of pictures by the artificial intelligence engine, wherein the AI companion agent is configured to mimic different personalities, wherein the AI companion agent's gender, age and ethnicity is determined by the artificial Intelligence's analysis on input from the user; wherein the AI companion agent is configured to be displayed in full body or half body portrait mode or a face on top of a moving robot, wherein the artificial intelligence engine is configured for real-time speech recognition, speech to text generation, real-time dialog generation, text to speech generation, voice-driven animation, and human avatar generation, wherein the AI companion agent is figured to share personalized promotions based on the user's shopping history, wherein the AI companion can be run both online with internet and offline without internet;
Accessing the user's taste history on clothing, wherein the AI companion agent searches and retrieves the user's past preferences and purchase history related to clothing items;
Familiarizing with the user's clothing preferences, wherein the AI companion agent analyzes and understands the user's preferred types of clothing, such as dresses, shirts, and preferred colors;
Engaging in a dialog with the user, wherein the AI companion agent inquiries about the specific clothing item the user desires, including type and color;
Allowing detailed user inputs, wherein the user describes the desired clothing item in detail, specifying style, color, and other characteristics;
Recommending clothing based on user preferences, wherein the AI companion agent suggests suitable clothing items based on the user's taste history, occasion, and personal style;
Extending recommendations to family and friends, wherein the AI companion agent provides clothing suggestions for the user's family members and friends by remembering their names and preferences;
Differentiating between similar items, wherein the AI companion agent informs the user about the differences between the similar items;
Prompting related purchases, wherein the AI companion agent reminds the user to buy related items when a particular item is selected;
Training on various fields of knowledge, wherein the AI companion agent is equipped with knowledge from different domains to assist the user comprehensively;
Retrieving user's life history, wherein the AI agent searches and retrieves the user's past preferences and history on life, view, news, and food preferences;
Engaging in topical conversations, wherein the AI agent chats with the user on topics of interest to the user, including current news, and selects news articles based on the user's preferences and interests;
Conversing about selected topics, wherein the AI agent engages in conversations about topics the user selects for any day;
Discussing shopping experiences, wherein the AI agent engages in conversations with the user about their shopping experiences and may give suggestions. Recommending relevant products;
Providing knowledges in different domains, wherein the different domains comprise domains of beauty evaluation, nutrients, important features and trends of a specific product and other fields;
Helping users compare different products;
Sending reminders for relevant activities and products;

8. The method for personalizing a shopping experience using an artificial intelligence (AI ) companion agent of claim 7, wherein the AI companion agent is configured to provide multi-platform accessibility, wherein the AI companion agent can operate on a TV screen or as an app on a smartphone.

9. The method for personalizing a shopping experience using an artificial intelligence (AI ) companion agent of claim 8, wherein the artificial intelligence engine is configured to emulate different voices and use different languages.
